(19) United States
(12) Patent Application Publication
(10) Pub. No.: US 2020/0114340 A1
(43) Pub. Date: Apr. 16, 2020

(54) A COMPOSITION COMPRISING A ZEOLITIC MATERIAL SUPPORTED ON A SUPPORT MATERIAL

(71) Applicant: BASF SE, Ludwigshafen am Rhein (DE)

(72) Inventors: Mathias FEYEN, Ludwigshafen (DE); Ulrich MUELLER, Ludwigshafen (DE); Xinhe BAO, Dalian City (CN); Weiping ZHANG, Dalian City (CN); Dirk de VOS, Leuven (BE); Hermann GIES, Bochum (DE); Feng-Shou XIAO, Hangzhou (CN); Yokoi TOSHIYUKI, Tokyo (JP); Ute KOLB, Mainz (DE); Bernd MARLER, Bochum (DE); Yong WANG, Shanghai (CN); Trees DE BAERDEMAEKER, Leuven (BE); Chuan SHI, Dalian City (CN); Xiulian PAN, Dalian City (CN); Xiangju MENG, Hangzhou (CN)

(73) Assignee: BASF SE, Ludwigshafen am Rhein (DE)

(21) Appl. No.: 16/607,551

(22) PCT Filed: Jun. 25, 2018
(86) PCT No.: PCT/CN2018/092580

§ 371 Date: Oct. 23, 2019

(30) Foreign Application Priority Data
Jun. 26, 2017 (CN) PCT/CN2017/090048

(51) Int. Cl. B01J 29/72; B01J 35/10; B01J 35/02; C01B 39/48; B01J 37/10; B01D 53/94

(52) U.S. Cl. CPC B01J 29/723; B01D 2255/9207; B01J 35/1038; B01J 35/026; C01B 39/48; B01J 37/10; B01D 53/9418; B01J 2229/186; B01J 2229/64; C01P 2002/72; C01P 2004/03; C01P 2006/12; C01P 2006/14; B01D 2255/20761; B01D 2255/50; B01D 2255/9205; B01J 35/1019

(57) ABSTRACT

A composition comprising a support material which comprises silicon carbide on the surface of which a zeolitic material of the AEI/CHA family is supported, wherein at least 99 weight-% of the framework structure of the zeolitic material consist of a tetravalent element Y which is one or more of Si, Ge, Ti, Sn and V; a trivalent element X which is one or more of Al, Ga, In, and B; O; and H.

The present invention relates to a composition comprising a support material comprising silicon carbide wherein on the surface of the support material a zeolitic material of the AEI/CHA family is supported, a process for preparing the composition, and its use as a catalyst or a catalyst component.

Zeolitic materials are widely studied for catalytic applications such as SCR with NH₃. Framework types of such zeolitic materials include, for example, MFI or BEA. Other materials which can be mentioned are SAPO-34 and SSZ-13 with CHA framework type, in particular those which contain copper and/or iron. However, their stability remains an issue due to undesired sintering of copper species and disruption of zeolitic crystallinity and porosity under harsh reaction conditions. CHA-type zeolitic materials with small pores and strong acidity, especially SSZ-13 zeolitic materials exchanged with copper show a good NH₃-SCR activity and selectivity. Generally, however, the respective zeolite-based catalysts may show deactivation above 550° C. In real applications, the temperature can shoot up beyond 800° C., which frequently decreases the durability of the catalyst.

It was an object of the present invention to provide an improved material which, preferably when used as a catalyst or catalyst component, in particular in the treatment of an exhaust gas stream of a diesel engine.

Therefore, the present invention relates to a composition comprising a support material comprising silicon carbide, wherein on the surface of the support material a zeolitic material of the AEI/CHA family is supported, wherein at least 99 weight-% of the framework structure of the zeolitic material consist of a tetravalent element Y which is one or more of Si, Ge, Ti, Sn and V; a trivalent element X which is one or more of Al, Ga, In, and B; O; and H.

Generally, no particular restrictions exist regarding the chemical nature of the silicon carbide comprised in the support material. Preferably, the silicon carbide comprised in the support material comprises one or more of alpha silicon carbide, beta silicon carbide, and gamma silicon carbide. More preferably, the silicon carbide comprised in the support material is one or more of alpha silicon carbide, beta silicon carbide, and gamma silicon carbide, more preferably alpha silicon carbide. More preferably, at least 90 weight-%, more preferably at least 95 weight-%, more preferably at least 99 weight-% of the silicon carbide comprised in the support material consist of alpha silicon carbide.

Generally, it is possible that the support material consists or essentially consists of silicon carbide. Preferably, the support material comprises, in addition to silicon carbide, one or more further components, wherein one or more of these further components preferably comprise silicon, either as elemental silicon or as a compound comprising silicon wherein this compound is not a silicon carbide. More preferably, the support material comprises, in addition to silicon carbide, one or more further components comprising silicon, more preferably one or more of silicon and silica, more preferably silicon and silica. It is preferred that at least 95 weight-%, more preferably at least 98 weight-%, more preferably at least 99 weight-% of the support material consist of silicon carbide, elemental silicon, and silica. It is further preferred that at least 50 weight-%, more preferably at least 60 weight-%, more preferably at least 65 weight-% of the support material consist of silicon carbide. Preferred support materials comprise, for example, silicon carbide in an amount in the range of from 50 to 80 weight-%, more preferably in the range of from 60 to 75 weight-%, more preferably in the range of from 65 to 70 weight-%, based on the weight of the support material. Preferred support materials comprise, for example, elemental silicon in an amount in the range of from 5 to 30 weight-%, more preferably in the range of from 10 to 25 weight-%, more preferably in the range of from 15 to 20 weight-%, based on the weight of the support material. Preferred support materials comprise, for example, silica in an amount in the range of from 5 to 30 weight-%, more preferably in the range of from 10 to 25 weight-%, more preferably in the range of from 15 to 20 weight-%, based on the weight of the support material. Therefore, it is preferred that the support material comprises silicon carbide in an amount in the range of from 50 to 80 weight-%, elemental silicon in an amount in the range of from 5 to 30 weight-%, and silica in an amount ion the range of from 5 to 30 weight-%, in each case based on the weight of the support material, wherein preferably at least 95 weight-%, more preferably at least 98 weight-%, more preferably at least 99 weight-% of the support material consist of silicon carbide, elemental silicon, and silica. Therefore, it is further preferred that the support material comprises silicon carbide in an amount in the range of from 60 to 75 weight-%, elemental silicon in an amount in the range of from 10 to 25 weight-%, and silica in an amount ion the range of from 10 to 25 weight-%, in each case based on the weight of the support material, wherein preferably at least 95 weight-%, more preferably at least 98 weight-%, more preferably at least 99 weight-% of the support material consist of silicon carbide, elemental silicon, and silica. Therefore, it is further preferred that the support material comprises silicon carbide in an amount in the range of from 65 to 70 weight-%, elemental silicon in an amount in the range of from 15 to 20 weight-%, and silica in an amount ion the range of from 15 to 20 weight-%, in each case based on the weight of the support material, wherein preferably at least 95 weight-%, more preferably at least 98 weight-%, more preferably at least 99 weight-% of the support material consist of silicon carbide, elemental silicon, and silica.

Generally, the support material can be present in any conceivable form, including, but not restricted to, as a powder including a spray-powder, a granulate including a spray-granulate, a molding, including a molding having a rectangular, a triangular, a hexagonal, a square, an oval or a circular cross section, and/or being in the form of a star, a tablet, a sphere, a cylinder, a strand, a hollow cylinder, a brick, wherein the molding can be prepared, for example, by extrusion, pressing, or any other suitable method. Preferably, the support material is in the form of a molding. It is noted that the term “the support material is in the form of a molding” as used in the context of the present invention refers to a support material which is present as one single molding and also refers to a support material which is present as two or more moldings such as a multitude of moldings. Preferably, the molding is in the form of brick which, more preferably, comprises one or more channels with an open inlet end and open outlet end. Generally, the dimensions of the molding can be adjusted to the specific needs based on the intended use of the composition of the present invention.

Regarding the zeolitic material which is comprised in the composition, it is preferred that it is a zeolitic material having framework type AEI, a zeolitic material having framework type CHA, or a mixture of a zeolitic material having framework type AEI and a zeolitic material having framework type CHA. More preferably, the zeolitic material comprises, more preferably is a zeolitic material having framework type CHA.

Preferably at least 99.5 weight-% of the framework structure of the zeolitic material consist of a tetravalent element Y which is one or more of Si, Ge, Ti, Sn and V; a trivalent element X which is one or more of Al, Ga, In, and B; O; and H. Regarding Y, it is preferred that Y comprises Si, more preferably that Y is Si. Regarding X, it is preferred that X comprises Al, more preferably that X is Al. Therefore, it is preferred that the zeolitic material comprised in the composition of the present invention is a zeolitic material having framework type CHA wherein at least 99 weight-%, more preferably at least 99.5 weight-% of the framework structure of the zeolitic material consist of Si, Al, O, and H. Regarding the molar ratio of Y relative to X in the framework of the zeolitic material, no specific restrictions exist. Preferably, the molar ratio of Y relative to X, calculated as YO₂:X₂O₃, is at least 10:1, preferably at least 15:1, more preferably at least 20:1. Therefore, it is preferred that Y is Si and X is Al, wherein the molar ratio of Si relative to Al, calculated as SiO₂:Al₂O₃, is at least 10:1, preferably at least 15:1, more preferably at least 20:1. Usually, this molar ratio SiO₂:Al₂O₃ is referred to as “SAR”. More preferably, in the framework of the zeolitic material comprised in the composition, the molar ratio of Si relative to Al, calculated as SiO₂:Al₂O₃, is in the range of from 20:1 to 100:1, preferably in the range of from 25:1 to 75:1, more preferably in the range of from 30:1 to 40:1.

According to a first embodiment of the present invention, it is preferred that at least 95 weight-%, preferably at least 98 weight-%, more preferably at least 99 weight-%, such as from 99 to 100 weight-% of the composition consist of the support material and the zeolitic material. Therefore, the present invention preferably relates to a composition comprising a support material comprising silicon carbide, wherein on the surface of the support material a zeolitic material having framework type CHA is supported, wherein at least 99 weight-% of the framework structure of the zeolitic material consist of Si, Al, O, and H, and wherein at least 95 weight-%, more preferably at least 98 weight-%, more preferably at least 99 weight-% of the support material consist of silicon carbide, elemental silicon, and silica.

According to the present invention, the composition preferably has a BET specific surface area, determined as described in Reference Example 1.1 herein, in the range of from 100 to 300 m²/g, preferably in the range of from 150 to 250 m²/g. According to the present invention, the composition preferably has a specific micropore surface area (S_{mic}), determined as described in Reference Example 1.2 herein, in the range of from 100 to 250 m²/g, preferably in the range of from 150 to 200 m²/g. According to the present invention, the composition preferably has an external surface area (Sₑₓₜ), determined as described in Reference Example 1.3 herein, in the range of from 2 to 10 m²/g, preferably in the range of from 3 to 9 m²/g. According to the present invention, the composition preferably has a total pore volume (Vₜ), determined as described in Reference Example 1.4 herein, in the range of from 0.05 to 0.20 cm³/g, preferably in the range of from 0.08 to 0.15 cm³/g. According to the present invention, the composition preferably has a micropore volume (V_{mic}), determined as described in Reference Example 1.5 herein, in the range of from 0.04 to 0.15 cm³/g, preferably in the range of from 0.07 to 0.12 cm³/g. According to the present invention, the composition preferably has an adsorption cumulative pore volume (V_{BJH}), determined as described in Reference Example 1.6 herein, in the range of from 0.002 to 0.02 cm³/g, preferably in the range of from 0.005 to 0.015 cm³/g. According to the present invention, the composition preferably has a loading of the support material with the zeolitic material, determined as described in Reference Example 1.7 herein, in the range of from 5 to 50%, preferably in the range of from 15 to 45%, more preferably in the range of from 25 to 40%.

Preferably, the crystallites of the zeolitic material supported on the surface of the support material are, or essentially are, in the form of cubes wherein at least 90% of the cubes have an edge length in the range of from 1 to 10 micrometer, preferably in the range of from 1.5 to 8.5 micrometer, more preferably in the range of from 2 to 7 micrometer, determined as described in Reference Example 1.8.

According to the present invention, the composition, in addition to the support material and the zeolitic material described above, may further comprise a transition metal wherein the transition metal preferably comprises one or more of Cu and Fe, more preferably is Cu, or Fe, or Cu and Fe. More preferably, the transition metal comprises, more preferably is Cu.

Regarding the amount of transition metal, preferably Cu, comprised in the composition, no specific restrictions exits. Preferably, the amount is adjusted to the respective needs according to the intended use of the composition. Preferably, in the composition, the weight ratio of the transition metal, calculated as element, relative to the zeolitic material is in the range of from 0.1:1 to 5.0:1, more preferably in the range of from 0.5:1 to 4.0:1, more preferably in the range of from 1.0:1 to 3.0:1. More preferably, in the composition, the weight ratio of the transition metal, calculated as element, relative to the zeolitic material is in the range of from 1.0:1 to 2.5.0:1, more preferably in the range of from 1.5:1 to 2.0:1.

Generally, the transition metal may be comprised at any conceivable location or locations in the composition. Preferably, the transition metal is, or is essentially completely, comprised in the zeolitic material which is supported on the surface of the support material. More preferably, the transition metal is, or is essentially completely, comprised in the zeolitic material which is supported on the surface of the support material, wherein the transition metal comprised in the composition is introduced in a composition comprising the zeolitic material supported on the surface of the support material, preferably by impregnating said composition comprising the zeolitic material supported on the surface of the support material with a suitable source of the transition metal, as described hereinunder.

According to the present invention, it may be preferred that at least 90%, preferably at least 98%, more preferably at least 99% of the total amount of the transition metal comprised in the composition is present at exchange sites of the zeolitic material. Further, it is preferred that in the composition, the transition metal is present at least partly, preferably essentially completely in the form of one or more oxides.

Therefore, according to a second embodiment of the present invention, it is preferred that at least 95 weight-%, preferably at least 98 weight-%, more preferably at least 99 weight-%, such as from 99 to 100 weight-% of the composition consist of the support material, the zeolitic material, the transition metal and O. Therefore, the present invention preferably relates to a composition comprising a support material comprising silicon carbide, wherein on the surface of the support material a zeolitic material having framework type CHA is supported, wherein at least 99 weight-% of the framework structure of the zeolitic material consist of Si, Al, O, and H, wherein at least 95 weight-%, more preferably at least 98 weight-%, more preferably at least 99 weight-% of the support material consist of silicon carbide, elemental silicon, and silica, and wherein the composition further comprises a transition metal, preferably Cu, preferably present in the form of one or more oxides, wherein preferably at least 90%, more preferably at least 98% more preferably at least 99% of the total amount of the transition metal comprised in the composition is present at exchange sites of the zeolitic material.

Further, the present invention relates to a process for preparing the composition described above. No specific restrictions exist regarding how this process is carried out, provided that the respective composition is obtained. Preferably, the present invention relates to a process for preparing the composition as described above, comprising
(i) preparing an aqueous synthesis mixture comprising a source of Y, a source of X, a source of a base, preferably an AEI/CHA framework structure directing agent, and further comprising a support material comprising silicon carbide;
(ii) subjecting the synthesis mixture prepared in (i) to hydrothermal crystallization conditions, comprising heating the synthesis mixture prepared in (i) under autogenous pressure to a crystallization temperature of the zeolitic material of the AEI/CHA family and keeping the heated synthesis mixture at this crystallization temperature for a crystallization time, obtaining a crystallization mixture comprising the zeolitic material of the AEI/CHA family supported on the surface of the support material and the mother liquor.

After (ii), the mother liquor, after a suitable separation from the crystallization mixture, can be recycled to the synthesis process, optionally after one or more purification and/or work-up steps.

Regarding said sources of Y, X, and the base, no specific restrictions exits provided that according to (ii), the zeolitic material of the AEI/CHA family supported on the surface of the support material is obtained.

Preferably, if Y is Si, the source of Y comprises, more preferably is, one or more of a silicate, a silica, a silicic acid, a colloidal silica, a fumed silica, a tetraalkoxysilane, a silica hydroxide, a precipitated silica and a clay, preferably one or more of a wet-process silica, a dry-process silica, and colloidal silica. In this context, both so-called “wet-process silicon dioxide” as well as so called “dry-process silicon dioxide” can be employed. Colloidal silicon dioxide is, inter alia, commercially available as Ludox®, Syton®, Nalco®, or Snowtex®. “Wet process” silicon dioxide is, inter alia, commercially available as Hi-Sil®, Ultrasil®, Vulcasil®, Santocel®, Valron-Estersil®, Tokusil® or Nipsil®. “Dry process” silicon dioxide is commercially available, inter alia, as Aerosil®, Reolosil®, Cab-O-Sil®, Fransil® or ArcSilica®. Tetraalkoxysilanes, such as, for example, tetraethoxysilane or tetrapropoxysilane, may be mentioned.

Preferably, if X is Al, the source of X comprises, more preferably is, one or more of a metallic aluminum, an aluminate, an aluminum alcoholate and an aluminum hydroxide, more preferably one or more of an aluminum hydroxide and aluminumtriisopropylate, more preferably aluminum hydroxide.

Preferably, the source of a base is the source of one or more of an alkali metal and an alkaline earth metal, preferably an alkali metal base, more preferably an alkali metal hydroxide, more preferably sodium hydroxide.

The respective amount of the source of Y, the source of X, and the source of a base, it is preferred that in the synthesis mixture prepared in (i) and subjected to (ii), the weight ratio of the base relative to the sum of the weight of the source of Y, calculated as YO₂, and the weight of the source of X, calculated as X(OH)₃, is greater than 1.5:1, preferably greater than 2:1, more preferably in the range of from 3:1 to 10:1, more preferably in the range of from 4:1 to 9:1, more preferably in the range of from 5:1 to 8:1.

If the zeolitic material has framework type AEI, it is preferred that the AEI framework structure directing agent comprises one or more quaternary phosphonium cation containing compounds and/or one or more quaternary ammonium cation containing compounds;

wherein the one or more phosphonium cation containing compounds comprise one or more R¹R²R³R⁴P⁺-containing compounds, wherein R¹, R², R³, and R⁴ independently from one another stand for optionally substituted and/or optionally branched (C₁-C₆)alkyl, preferably (C₁-C₅)alkyl, more preferably (C₁-C₄)alkyl, more preferably (C₂-C₃)alkyl, and even more preferably for optionally substituted methyl or ethyl, wherein even more preferably R¹, R², R³, and R⁴ stand for optionally substituted ethyl, preferably unsubstituted ethyl;
wherein the one or more quaternary ammonium cation containing compounds comprise one or more N,N-dialkyl-dialkylpiperidinium cation containing compounds, preferably one or more N,N-(C₁-C₃)dialkyl-(C₁-C₃)dialkylpiperidinium cation containing compounds, more preferably one or more N,N-(C₁-C₂)dialkyl-(C₁-C₂)dialkylpiperi-dinium cation containing compounds, wherein more preferably, the one or more quaternary ammonium cation containing compounds are selected from the group consisting of N,N-(C₁-C₂)dialkyl-2,6-(C₁-C₂)dialkylpiperidinium cation and N,N-(C₁-C₂)dialkyl-3,5-(C₁-C₂)di-alkylpiperidinium cation containing compounds, more preferably from the group consisting of N,N-dimethyl-2,6-(C₁-C₂)dialkylpiperidinium cation and N,N-dimethyl-3,5-(C₁-C₂)dialkyl-piperidinium cation containing compounds, more preferably from the group consisting of N,N-dimethyl-2,6-dimethylpiperidinium cation and N,N-dimethyl-3,5-dimethyl-piperidinium cation containing compounds;
wherein the one or more quaternary phosphonium cation containing compounds and/or the one or more quaternary ammonium cation containing compounds are salts, preferably selected from the group consisting of halides, preferably chloride and/or bromide, more preferably chloride; hydroxide; sulfate; nitrate; phosphate; acetate; and mixtures of two or more thereof, more preferably from the group consisting of chloride, hydroxide, sulfate, and mixtures of two or more thereof, wherein more preferably the one or more quaternary phosphonium cation containing compounds and/or the one or more quaternary ammonium cation containing compounds are hydroxides and/or chlorides, and even more preferably hydroxides,
wherein more preferably, the AEI framework structure agent comprises, preferably is N,N-dimethyl-3,5-dimethylpiperidinium hydroxide.

If the zeolitic material has framework type CHA, it is preferred that the CHA framework structure directing agent comprises one or more of a N-alkyl-3-quinuclidinol, a N,N,N-trialkyl-exoaminonorbornane, a N,N,N-trimethyl-1-adamantylammonium compound, a N,N,N-trimethyl-2-adamantylammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzylammonium compound, preferably a hydroxide thereof, wherein more preferably, the CHA framework structure directing agent comprise one or more of a N,N,N-trimethyl-1-adamantylammonium compound, more preferably N,N,N-trimethyl-1-adamantylammonium hydroxide. Optionally, this suitable 1-adamantyltrimethylammonium compound can be employed in combination with at least one further suitable ammonium compound such as, e.g., a N,N,N-trimethylbenzylammonium (benzyltrimethylammonium) compound or a tetramethylammonium compound or a mixture of a benzyltrimethylammonium and a tetramethylammonium compound.

The hydrothermal synthesis according to (ii) can be carried out in any suitable vessel. Preferably, subjecting the synthesis mixture prepared in (i) to hydrothermal crystallization conditions according to (ii) is carried out in an autoclave.

Preferably, the crystallization temperature according to (ii) is in the range of from 130 to 200° C., more preferably in the range of from 140 to 190° C., more preferably in the range of from 150 to 180° C. Preferably, the crystallization time is greater than 24 h, more preferably in the range of from 36 to 144 h, more preferably in the range of from 42 to 120 h.

Preferably, after (ii), the process further comprises
(iii) cooling the crystallization mixture obtained from (ii), preferably to a temperature of the crystallization mixture in the range of from 10 to 50° C., more preferably in the range of from 20 to 35° C.

Preferably, after (ii) or (iii), more preferably after (iii), the process further comprises
(iv) separating the zeolitic material of the AEI/CHA family supported on the surface of the support material from the crystallization mixture obtained from (ii) or (iii), preferably from (iii).

Preferably, the separating according to (iv) comprises
(iv.1) subjecting the crystallization mixture obtained from (ii) or (iii), preferably from (iii), to a solid-liquid separation method, preferably comprising filtration or centrifugation, more preferably filtration, obtaining the zeolitic material of the AEI/CHA family supported on the surface of the support material;
(iv.2) preferably washing the zeolitic material of the AEI/CHA family supported on the surface of the support material, preferably with water;
(iv.3) drying the zeolitic material of the AEI/CHA family supported on the surface of the support material obtained from (iv.1), preferably from (iv.2);
   wherein according to (iv.3), the zeolitic material of the AEI/CHA family supported on the surface of the support material is preferably dried in a gas atmosphere having a temperature in the range of from 75 to 150° C., more preferably in the range of from 85 to 130° C., more preferably in the range of from 95 to 110° C. The gas atmosphere used for drying preferably comprises oxygen, more preferably is oxygen, air, synthetic air, or lean air.

Preferably, after (iv), the process further comprises
(v) calcining the zeolitic material of the AEI/CHA family supported on the surface of the support material obtained from (iv);
   wherein according to (v), the zeolitic material of the AEI/CHA family supported on the surface of the support material is preferably calcined in a gas atmosphere having a temperature in the range of from 450 to 700° C., more preferably in the range of from 475 to 650° C., more preferably in the range of from 500 to 600° C. The gas atmosphere used for calcination oxygen preferably comprises, more preferably is oxygen, air, synthetic air, or lean air. If the synthesis mixture prepared according to (i) does not contain the structure directing agent and if, therefore, the hydrothermal synthesis according to (ii) is carried out in the absence of the structure directing agent, it may be preferred that the calcination according to (v) is not carried out.

Depending on the intended use of the composition to be prepared, it may be preferred to further incorporate a transition metal into the composition. For this purpose, no specific restriction exists. For example, it may be conceivable that a zeolitic material is supported on the surface of the support material which already comprises the transition metal. It may be further conceivable that according to (i), a synthesis mixture is prepared which, in addition to the components described above, comprises a suitable source of the transition metal so that during the hydrothermal synthesis according to (ii), the transition metal is suitably incorporated in the zeolitic material during hydrothermal synthesis. Preferably according to the present invention, the transition metal is incorporated in a suitable post-treatment of the composition prepared according to the process described above. Therefore, the process preferably further comprises
(vi) subjecting the zeolitic material of the AEI/CHA family supported on the surface of the support material to ion-exchange with a transition metal, preferably one or more of Cu and Fe, more preferably with Cu.

Preferably, the ion-exchange according to (vi) comprises
(vi.1) preparing a mixture comprising the zeolitic material of the AEI/CHA family supported on the surface of the support material, a source of the transition metal, a solvent for the source of the metal M, and optionally an acid, preferably an organic acid, wherein the solvent preferably comprises water, the source of the transition metal preferably comprises a salt of the transition metal and the acid preferably comprises acetic acid;
(vi.2) heating the mixture prepared in (vi.2) to a temperature in the range of from 30 to 90° C., preferably in the range of from 40 to 80° C.

Preferably, the solvent for the source of the transition metal is water. Preferably, the salt of the transition metal is an inorganic salt, more preferably a nitrate.

Preferably, the process further comprises
(vi.3) cooling the mixture obtained from (vi.2), preferably to a temperature of the mixture in the range of from 10 to 50° C., more preferably in the range of from 20 to 35° C.

Preferably, the process further comprises
(vi.4) separating the zeolitic material of the AEI/CHA family supported on the surface of the support material comprising the transition metal from the mixture obtained from (vi.2) or (vi.3), preferably from (vi.3);
   wherein the separating preferably comprises
(vi.4.1) optionally washing the zeolitic material of the AEI/CHA family supported on the surface of the support material comprising the transition metal;
(vi A.2) drying the zeolitic material of the AEI/CHA family supported on the surface of the support material comprising the transition metal obtained from (vi.3) or (vi.4.1) in a gas atmosphere, preferably at a temperature of the gas atmosphere in the range of from 90 to 200° C., more preferably in the range of from 100 to 150° C., wherein the gas atmosphere preferably comprises oxygen.

Preferably, the process further comprises
(vi.5) calcining the zeolitic material of the AEI/CHA family supported on the surface of the support material comprising the transition metal obtained from (vi.4) in a gas atmosphere, preferably at a temperature of the gas atmosphere in the range of from 350 to 600° C., more preferably in the range of from 400 to 550° C., wherein the gas atmosphere preferably comprises oxygen.

Yet further, the present invention relates to a composition as described above, which is obtainable or obtained or preparable or prepared by a process as described above.

According to a preferred embodiment, the present invention relates to a composition comprising a support material comprising silicon carbide, wherein on the surface of the support material a zeolitic material having framework type CHA is supported, wherein at least 99 weight-% of the framework structure of the zeolitic material consist of Si, Al, O, and H, wherein at least 95 weight-%, more preferably at least 98 weight-%, more preferably at least 99 weight-% of the support material consist of silicon carbide, elemental silicon, and silica, and wherein the composition further comprises a transition metal, preferably Cu, preferably present in the form of one or more oxides, wherein preferably at least 90% more preferably at least 98% more preferably at least 99% of the total amount of the transition metal comprised in the composition is present at exchange sites of the zeolitic material, wherein said composition is obtainable or obtained by a process comprising, optionally consisting of,
(i) preparing an aqueous synthesis mixture comprising a source of Si, a source of Al, a source of a base, preferably an CHA framework structure directing agent, and further comprising a support material comprising silicon carbide;
(ii) subjecting the synthesis mixture prepared in (i) to hydrothermal crystallization conditions, comprising heating the synthesis mixture prepared in (i) under autogenous pressure to a crystallization temperature of the zeolitic material having framework type CHA and keeping the heated synthesis mixture at this crystallization temperature for a crystallization time, obtaining a crystallization mixture comprising the zeolitic material having framework type CHA supported on the surface of the support material and the mother liquor;
(iii) preferably cooling the crystallization mixture obtained from (ii), preferably to a temperature of the crystallization mixture in the range of from 10 to 50° C., more preferably in the range of from 20 to 35° C.;
(iv) preferably separating the zeolitic material having framework type CHA supported on the surface of the support material from the crystallization mixture obtained from (ii) or (iii), preferably from (iii), said separating preferably comprising
   (iv.1) subjecting the crystallization mixture obtained from (ii) or (iii), preferably from (iii), to a solid-liquid separation method, preferably comprising filtration or centrifugation, more preferably filtration, obtaining the zeolitic material having framework type CHA supported on the surface of the support material;
   (iv.2) preferably washing the zeolitic material having framework type CHA supported on the surface of the support material, preferably with water;
   (iv.3) drying the zeolitic material having framework type CHA supported on the surface of the support material obtained from (iv.1), preferably from (iv.2);
(v) preferably calcining the zeolitic material having framework type CHA supported on the surface of the support material obtained from (iv).

According to a preferred embodiment, the present invention relates to a composition comprising a support material comprising silicon carbide, wherein on the surface of the support material a zeolitic material having framework type CHA is supported, wherein at least 99 weight-% of the framework structure of the zeolitic material consist of Si, Al, O, and H, and wherein at least 95 weight-%, more preferably at least 98 weight-%, more preferably at least 99 weight-% of the support material consist of silicon carbide, elemental silicon, and silica, wherein said composition is obtainable or obtained by a process comprising, optionally consisting of,
(i) preparing an aqueous synthesis mixture comprising a source of Si, a source of Al, a source of a base, preferably an CHA framework structure directing agent, and further comprising a support material comprising silicon carbide;
(ii) subjecting the synthesis mixture prepared in (i) to hydrothermal crystallization conditions, comprising heating the synthesis mixture prepared in (i) under autogenous pressure to a crystallization temperature of the zeolitic material having framework type CHA and keeping the heated synthesis mixture at this crystallization temperature for a crystallization time, obtaining a crystallization mixture comprising the zeolitic material having framework type CHA supported on the surface of the support material and the mother liquor;
(iii) preferably cooling the crystallization mixture obtained from (ii), preferably to a temperature of the crystallization mixture in the range of from 10 to 50° C., more preferably in the range of from 20 to 35° C.;
(iv) preferably separating the zeolitic material having framework type CHA supported on the surface of the support material from the crystallization mixture obtained from (ii) or (iii), preferably from (iii), said separating preferably comprising
   (iv.1) subjecting the crystallization mixture obtained from (ii) or (iii), preferably from (iii), to a solid-liquid separation method, preferably comprising filtration or centrifugation, more preferably filtration, obtaining the zeolitic material having framework type CHA supported on the surface of the support material;
   (iv.2) preferably washing the zeolitic material having framework type CHA supported on the surface of the support material, preferably with water;
   (iv.3) drying the zeolitic material having framework type CHA supported on the surface of the support material obtained from (iv.1), preferably from (iv.2);
(v) preferably calcining the zeolitic material having framework type CHA supported on the surface of the support material obtained from (iv);
(vi) subjecting the zeolitic material having framework type CHA supported on the surface of the support material to ion-exchange with a transition metal, preferably one or more of Cu and Fe, more preferably with Cu, said subjecting preferably comprising
   (vi.1) preparing a mixture comprising the zeolitic material having framework type CHA supported on the surface of the support material, a source of the transition metal, a solvent for the source of the transition metal, and optionally an acid, preferably an organic acid, wherein the solvent preferably comprises water, the source of the transition metal preferably comprises a salt of the transition metal and the acid preferably comprises acetic acid;
   (vi.2) heating the mixture prepared in (vi.2) to a temperature in the range of from 30 to 90° C., preferably in the range of from 40 to 80° C.;
   (vi.3) preferably cooling the mixture obtained from (vi.2), preferably to a temperature of the mixture in the range of from 10 to 50° C. more preferably in the range of from 20 to 35° C.;
   (vi.4) preferably separating the zeolitic material having framework type CHA supported on the surface of the support material comprising the transition metal from the mixture obtained from (vi.2) or (vi.3), preferably from (vi.3), said separating preferably comprising
      (vi.4.1) optionally washing the zeolitic material having framework type CHA supported on the surface of the support material comprising the transition metal;
      (vi.4.2) drying the zeolitic material having framework type CHA supported on the surface of the support material comprising the transition metal obtained from (vi.3) or (vi.4.1) in a gas atmosphere, preferably at a temperature of the gas atmosphere in the range of from 90 to 200° C., more preferably in the range of from 100 to 150° C., wherein the gas atmosphere preferably comprises oxygen;
   (vi.5) calcining the zeolitic material having framework type CHA supported on the surface of the support material comprising the transition metal obtained from (vi.4) in a gas atmosphere, preferably at a temperature of the gas atmosphere in the range of from 350 to 600° C., more preferably in the range of from 400 to 550° C., wherein the gas atmosphere preferably comprises oxygen.

The composition according to the present invention can be employed according to any conceivable use, for example as a molecular sieve, an adsorbent, an absorbent, or as a catalyst or a catalyst component. Preferably, it is used as a catalyst or a catalyst component. In particular in case the composition comprises the transition metal, preferably Cu and/or Fe, more preferably Cu, it is preferably used as a catalyst or a catalyst component in the treatment of an exhaust gas stream, preferably in the treatment of an exhaust gas stream of a diesel engine. If used accordingly, it is preferred that this use allows for selectively reducing nitrogen oxides comprised in an exhaust gas stream. It is further conceivable that the composition is used as a catalyst or a catalyst component for the conversion of a Cl compound to one or more olefins, preferably for the conversion of methanol to one or more olefins or the conversion of a synthetic gas comprising carbon monoxide and hydrogen to one or more olefins.

The present invention is further illustrated by the following embodiments and combinations of embodiments as indicated by the respective dependencies and back-references. In particular, it is noted that if a range of embodiments is mentioned, for example in the context of a term such as “The composition of any one of embodiments 1 to 4”, every embodiment in this range is meant to be disclosed for the skilled person, i.e. the wording of this term is to be understood by the skilled person as being synonymous to “The composition of any one of embodiments 1, 2, 3, and 4”.
1. A composition comprising a support material comprising silicon carbide, wherein on the surface of the support material a zeolitic material of the AEI/CHA family is supported, wherein at least 99 weight-% of the framework structure of the zeolitic material consist of a tetravalent element Y which is one or more of Si, Ge, Ti, Sn and V; a trivalent element X which is one or more of Al, Ga, In, and B; O; and H.
2. The composition of embodiment 1, wherein the silicon carbide comprised in the support material comprises one or more of alpha silicon carbide, beta silicon carbide, and gamma silicon carbide.
3. The composition of embodiment 1 or 2, wherein the silicon carbide comprised in the support material is one or more of alpha silicon carbide, beta silicon carbide, and gamma silicon carbide, preferably alpha silicon carbide, wherein more preferably, at least 90 weight-%, more preferably at least 95 weight-%, more preferably at least 99 weight-% of the silicon carbide consist of alpha silicon carbide.
4. The composition of any one of embodiments 1 to 3, wherein at least 50 weight-%, preferably at least 60 weight-%, more preferably at least 65 weight-% of the support material consist of silicon carbide, wherein the support material optionally further comprises one or more of elemental silicon and silica, preferably elemental silicon and silica.
5. The composition of embodiment 4, wherein at least 95 weight-%, preferably at least 98 weight-%, more preferably at least 99 weight-% of the support material consist of silicon carbide, elemental silicon, and silica.
6. The composition of any one of embodiments 1 to 5, wherein the support material is in the form of a molding.
7. The composition of embodiment 6, wherein the molding is preferably in the form of brick preferably comprising one or more channels with an open inlet end and open outlet end.
8. The composition of any one of embodiments 1 to 7, wherein the zeolitic material of the AEI/CHA family is a zeolitic material having framework type AEI or having framework type CHA.
9. The composition of any one of embodiments 1 to 8, wherein the zeolitic material of the AEI/CHA family is a zeolitic material having framework CHA.
10. The composition of any one of embodiments 1 to 9, wherein at least 99.5 weight-% of the framework structure of the zeolitic material consist of a tetravalent element Y which is one or more of Si, Ge, Ti, Sn and V; a trivalent element X which is one or more of Al, Ga, In, and B; O; and H.
11. The composition of any one of embodiments 1 to 10, wherein Y is Si.
12. The composition of any one of embodiments 1 to 11, wherein X is Al.
13. The composition of any one of embodiments 1 to 12, wherein Y is Si and X is Al, wherein the molar ratio of Si relative to Al, calculated as SiO₂:Al₂O₃, is at least 10:1, preferably at least 15:1, more preferably at least 20:1.
14. The composition of any one of embodiments 1 to 13, wherein the molar ratio of Si relative to Al, calculated as SiO₂:Al₂O₃, is in the range of from 20:1 to 100:1, preferably in the range of from 25:1 to 75:1, more preferably in the range of from 30:1 to 40:1.
15. The composition of any one of embodiments 1 to 14, wherein at least 95 weight-%, preferably at least 98 weight-%, more preferably at least 99 weight-% of the composition consist of the support material and the zeolitic material.
16. The composition of any one of embodiments 1 to 15, having a BET specific surface area, determined as described in Reference Example 1.1 herein, in the range of from 100 to 300 m²/g, preferably in the range of from 150 to 250 m²/g.
17. The composition of any one of embodiments 1 to 16, having a specific micropore surface area (S_{mic}), determined as described in Reference Example 1.2 herein, in the range of from 100 to 250 m²/g, preferably in the range of from 150 to 200 m²/g.
18. The composition of any one of embodiments 1 to 17, having an external surface area (Sₑₓₜ), determined as described in Reference Example 1.3 herein, in the range of from 2 to 10 m²/g, preferably in the range of from 3 to 9 m²/g.
19. The composition of any one of embodiments 1 to 18, having a total pore volume (Vₜ), determined as described in Reference Example 1.4 herein, in the range of from 0.05 to 0.20 cm³/g, preferably in the range of from 0.08 to 0.15 cm³/g.
20. The composition of any one of embodiments 1 to 19, having a micropore volume (V_{mic}), determined as described in Reference Example 1.5 herein, in the range of from 0.04 to 0.15 cm³/g, preferably in the range of from 0.07 to 0.12 cm³/g.
21. The composition of any one of embodiments 1 to 20, having an adsorption cumulative pore volume (V_{BJH}), determined as described in Reference Example 1.6 herein, in the range of from 0.002 to 0.02 cm³/g, preferably in the range of from 0.005 to 0.015 cm³/g.
22. The composition of any one of embodiments 1 to 21, wherein the loading of the support material with the zeolitic material, determined as described in Reference Example 1.7 herein, is in the range of from 5 to 50%, preferably in the range of from 15 to 45%, more preferably in the range of from 25 to 40%.
23. The composition of any one of embodiments 1 to 22, wherein the crystallites of the zeolitic material supported on the surface of the support material are in the form of cubes wherein at least 90% of the cubes have an edge length in the range of from 1 to 10 micrometer, preferably in the range of from 1.5 to 8.5 micrometer, more preferably in the range of from 2 to 7 micrometer, determined as described in Reference Example 1.8.
24. The composition of any one of embodiments 1 to 23, further comprising a transition metal.
25. The composition of embodiment 24, wherein the transition metal comprises one or more of Cu and Fe, preferably is Cu, or Fe, or Cu and Fe.
26. The composition of embodiment 24 or 25, wherein the transition metal comprises, preferably is Cu.
27. The composition of any one of embodiments 24 to 26, wherein in the composition, the weight ratio of the transition metal, calculated as element, relative to the zeolitic material is in the range of from 0.1:1 to 5.0:1, preferably in the range of from 0.5:1 to 4.0:1, more preferably in the range of from 1.0:1 to 3.0:1.
28. The composition of any one of embodiments 24 to 27, wherein in the composition, the weight ratio of the transition metal, calculated as element, relative to the zeolitic material is in the range of from 1.0:1 to 2.5.0:1, preferably in the range of from 1.5:1 to 2.0:1.
29. The composition of any one of embodiments 24 to 28, wherein at least 90%, preferably at least 98%, more preferably at least 99% of the total amount of the transition metal comprised in the composition is present at exchange sites of the zeolitic material.
30. The composition of any one of embodiments 24 to 29, wherein in the composition, the transition metal is present at least partly in the form of one or more oxides.
31. The composition of any one of embodiments 24 to 30, wherein at least 95 weight-%, preferably at least 98 weight-%, more preferably at least 99 weight-% of the composition consist of the support material, the zeolitic material, the transition metal and O.
32. The composition of any one of embodiments 24 to 31 for use as a catalyst or a catalyst component, preferably in the treatment of an exhaust gas stream, more preferably in the treatment of an exhaust gas stream of a diesel engine, more preferably in the selective catalytic reduction of nitrogen oxides comprised in an exhaust gas stream of a diesel engine.
33. A process for preparing the composition of any one of embodiments 1 to 32, comprising
   (i) preparing an aqueous synthesis mixture comprising a source of Y, a source of X, a source of a base, preferably an AEI/CHA framework structure directing agent, and further comprising a support material comprising silicon carbide;
   (ii) subjecting the synthesis mixture prepared in (i) to hydrothermal crystallization conditions, comprising heating the synthesis mixture prepared in (i) under autogenous pressure to a crystallization temperature of the zeolitic material of the AEI/CHA family and keeping the heated synthesis mixture at this crystallization temperature for a crystallization time, obtaining a crystallization mixture comprising the zeolitic material of the AEI/CHA family supported on the surface of the support material and the mother liquor.
34. The process of embodiment 33, wherein Y is Si and the source of Y comprises one or more of a silicate, a silica, a silicic acid, a colloidal silica, a fumed silica, a tetraalkoxysilane, a silica hydroxide, a precipitated silica and a clay, preferably one or more of a wet-process silica, a dry-process silica, and colloidal silica.
35. The process of embodiment 33 or 34, wherein X is Al and the source of X is one or more of a metallic aluminum, an aluminate, an aluminum alcoholate and an aluminum hydroxide, more preferably one or more of an aluminum hydroxide and aluminumtriisopropylate, more preferably aluminum hydroxide.
36. The process of any one of embodiments 33 to 35, wherein the source of a base is the source of one or more of an alkali metal and an alkaline earth metal, preferably an alkali metal base, more preferably an alkali metal hydroxide, more preferably sodium hydroxide.
37. The process of embodiment 36, wherein in the synthesis mixture prepared in (i) and subjected to (ii), the weight ratio of the base relative to the sum of the weight of the source of Y, calculated as YO₂, and the weight of the source of X, calculated as X(OH)₃, is greater than 1.5:1, preferably greater than 2:1, more preferably in the range of from 3:1 to 10:1, more preferably in the range of from 4:1 to 9:1, more preferably in the range of from 5:1 to 8:1.
38. The process of any one of embodiments 33 to 37, wherein the zeolitic material has framework type AEI and the AEI framework structure directing agent comprises one or more quaternary phosphonium cation containing compounds and/or one or more quaternary ammonium cation containing compounds;
   wherein the one or more phosphonium cation containing compounds comprise one or more R¹R²R³R⁴P⁺-containing compounds, wherein R¹, R², R³, and R⁴ independently from one another stand for optionally substituted and/or optionally branched (C₁-C₆)alkyl, preferably (C₁-C₅)alkyl, more preferably (C₁-C₄)alkyl, more preferably (C₂-C₃)alkyl, and even more preferably for optionally substituted methyl or ethyl, wherein even more preferably R¹, R², R³, and R⁴ stand for optionally substituted ethyl, preferably unsubstituted ethyl;
   wherein the one or more quaternary ammonium cation containing compounds comprise one or more N,N-dialkyl-dialkylpiperidinium cation containing compounds, preferably one or more N,N-(C₁-C₃)dialkyl-(C₁-C₃)dialkylpiperidinium cation containing compounds, more preferably one or more N,N-(C₁-C₂)dialkyl-(C₁-C₂)dialkylpiperidinium cation containing compounds, wherein more preferably, the one or more quaternary ammonium cation containing compounds are selected from the group consisting of N,N-(C₁-C₂)dialkyl-2,6-(C₁-C₂)dialkylpiperidinium cation and N,N-(C₁-C₂)dialkyl-3,5-(C₁-C₂)di-alkylpiperidinium cation containing compounds, more preferably from the group consisting of N,N-dimethyl-2,6-(C₁-C₂)dialkylpiperidinium cation and N,N-dimethyl-3,5-(C₁-C₂)dialkyl-piperidinium cation containing compounds, more preferably from the group consisting of N,N-dimethyl-2,6-dimethylpiperidinium cation and N,N-dimethyl-3,5-dimethyl-piperidinium cation containing compounds;
   wherein the one or more quaternary phosphonium cation containing compounds and/or the one or more quaternary ammonium cation containing compounds are salts, preferably selected from the group consisting of halides, preferably chloride and/or bromide, more preferably chloride; hydroxide; sulfate; nitrate; phosphate; acetate; and mixtures of two or more thereof, more preferably from the group consisting of chloride, hydroxide, sulfate, and mixtures of two or more thereof, wherein more preferably the one or more quaternary phosphonium cation containing compounds and/or the one or more quaternary ammonium cation containing compounds are hydroxides and/or chlorides, and even more preferably hydroxides,
   wherein more preferably, the AEI framework structure agent comprises, preferably is N,N-dimethyl-3,5-dimethylpiperidinium hydroxide.
39. The process of any one of embodiments 33 to 37, wherein the zeolitic material has framework type CHA and the CHA framework structure directing agent comprises one or more of a N-alkyl-3-quinuclidinol, a N,N,N-trialkyl-exoaminonorbornane, a N,N,N-trimethyl-1-adamantylammonium compound, a N,N,N-trimethyl-2-adamantylammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzylammonium compound, preferably a hydroxide thereof, wherein more preferably, the CHA framework structure directing agent comprise one or more of a N,N,N-trimethyl-1-adamantylammonium compound, more preferably N,N,N- ethyl-1-adamantylammonium hydroxide.
40. The process of any one of embodiments 33 to 39, wherein subjecting the synthesis mixture prepared in (i) to hydrothermal crystallization conditions according to (ii) is carried out in an autoclave.
41. The process of any one of embodiments 33 to 40, wherein the crystallization temperature according to (ii) is in the range of from 130 to 200° C., preferably in the range of from 140 to 190° C., more preferably in the range of from 150 to 180° C.
42. The process of any one of embodiments 33 to 41, wherein the crystallization time is greater than 24 h, preferably in the range of from 36 to 144 h, more preferably in the range of from 42 to 120 h.
43. The process of any one of embodiments 33 to 42, further comprising
   (iii) cooling the crystallization mixture obtained from (ii), preferably to a temperature of the crystallization mixture in the range of from 10 to 50° C., more preferably in the range of from 20 to 35° C.
44. The process of any one of embodiments 33 to 43, further comprising
   (iv) separating the zeolitic material of the AEI/CHA family supported on the surface of the support material from the crystallization mixture obtained from (ii) or (iii), preferably from (iii).
45. The process of embodiment 44, comprising
   (iv.1) subjecting the crystallization mixture obtained from (ii) or (iii), preferably from (iii), to a solid-liquid separation method, preferably comprising filtration or centrifugation, more preferably filtration, obtaining the zeolitic material of the AEI/CHA family supported on the surface of the support material;
   (iv.2) preferably washing the zeolitic material of the AEI/CHA family supported on the surface of the support material, preferably with water;
   (iv.3) drying the zeolitic material of the AEI/CHA family supported on the surface of the support material obtained from (iv.1), preferably from (iv.2).
46. The process of embodiment 45, wherein according to (iv.3), the zeolitic material of the AEI/CHA family supported on the surface of the support material is dried in a gas atmosphere having a temperature in the range of from 75 to 150° C., preferably in the range of from 85 to 130° C., more preferably in the range of from 95 to 110° C.
47. The process of embodiment 46, wherein the gas atmosphere comprises oxygen, preferably is oxygen, air, synthetic air, or lean air.
48. The process of any one of embodiments 33 to 47, preferably 43 to 47, more preferably 44 to 47, further comprising
   (v) calcining the zeolitic material of the AEI/CHA family supported on the surface of the support material obtained from (ii), preferably from (iii), more preferably from (iv).
49. The process of embodiment 48, wherein according to (v), the zeolitic material of the AEI/CHA family supported on the surface of the support material is calcined in a gas atmosphere having a temperature in the range of from 450 to 700° C., preferably in the range of from 475 to 650° C., more preferably in the range of from 500 to 600° C.
50. The process of embodiment 49, wherein the gas atmosphere comprises oxygen, preferably is oxygen, air, synthetic air, or lean air.
51. The process of any one of embodiments 44 to 50, further comprising
   (vi) subjecting the zeolitic material of the AEI/CHA family supported on the surface of the support material to ion-exchange with a transition metal, preferably one or more of Cu and Fe. more preferably with Cu.
52. The process of embodiment 51, wherein (vi) comprises
   (vi.1) preparing a mixture comprising the zeolitic material of the AEI/CHA family supported on the surface of the support material, a source of the transition metal, a solvent for the source of the transition metal, and optionally an acid, preferably an organic acid, wherein the solvent preferably comprises water, the source of the transition metal preferably comprises a salt of the transition metal and the acid preferably comprises acetic acid;
   (vi.2) heating the mixture prepared in (vi.2) to a temperature in the range of from 30 to 90° C., preferably in the range of from 40 to 80° C.
53. The process of embodiment 52, further comprising
(vi.3) cooling the mixture obtained from (vi.2), preferably to a temperature of the mixture in the range of from 10 to 50° C., more preferably in the range of from 20 to 35° C.
54. The process of embodiment 52 or 53, preferably 53, further comprising
   (vi.4) separating the zeolitic material of the AEI/CHA family supported on the surface of the support material comprising the transition metal from the mixture obtained from (vi.2) or (vi.3), preferably from (vi.3).
55. The process of embodiment 54, wherein the separating comprises
   (vi.4.1) optionally washing the zeolitic material of the AEI/CHA family supported on the surface of the support material comprising the transition metal;
   (vi.4.2) drying the zeolitic material of the AEI/CHA family supported on the surface of the support material comprising the transition metal obtained from (vi.3) or (vi.4.1) in a gas atmosphere, preferably at a temperature of the gas atmosphere in the range of from 90 to 200° C., more preferably in the range of from 100 to 150° C., wherein the gas atmosphere preferably comprises oxygen.
56. The process of embodiment 54 or 55, further comprising
   (vi.5) calcining the zeolitic material of the AEI/CHA family supported on the surface of the support material comprising the transition metal obtained from (vi.4) in a gas atmosphere, preferably at a temperature of the gas atmosphere in the range of from 350 to 600° C., more preferably in the range of from 400 to 550° C., wherein the gas atmosphere preferably comprises oxygen.
57. A composition of any one of embodiments 1 to 23, obtainable or obtained or preparable or prepared by a process according to any one of embodiments 33 to 50.
58. A composition of any one of embodiments 24 to 32, obtainable or obtained or preparable or prepared by a process according to any one of embodiments 33 to 56, preferably according to any one of embodiments 51 to 56.
59. Use of a composition according to any one of embodiments 1 to 32 or 57 or 58 as a catalyst or a catalyst component.
60. The use of embodiment 59 in the treatment of an exhaust gas stream, preferably in the treatment of an exhaust gas stream of a diesel engine.
61. The use of embodiment 60 wherein in the treatment, nitrogen oxides comprised in an exhaust gas stream of a diesel engine are selectively reduced.
62. A method for treating an exhaust gas stream, preferably an exhaust gas stream of a diesel engine, the method comprising bringing the exhaust gas stream in contact with a catalyst comprising a composition of any one of embodiments 1 to 32 or 57 or 58.
63. The method of embodiment 62, wherein by bringing the exhaust gas stream in contact with a catalyst comprising a composition of any one of embodiments 1 to 32 or 57 or 58, nitrogen oxides comprised in an exhaust gas stream of a diesel engine are selectively reduced.

The present invention is further illustrated by the following Reference Examples, Examples, and Reference Examples.

### EXAMPLES

### Reference Example 1.1: Determination of the BET Specific Surface Area

The BET specific surface area was determined according to DIN 66131 via N₂ adsorption-desorption at 77 K using a Quantachrome QUADRASORB SI system. The specific surface areas of the samples were calculated by the Brunauer-Emmett-Teller (BET) equation.

### Reference Example 1.2: Determination of S_{mic}

The specific micropore surface area (S_{mic}) was determined according to the method of Reference Example 1.1, calculated by the T-Plot method.

### Reference Example 1.3: Determination of Sₑₓₜ

The external surface area (Sₑₓₜ) was calculated as the difference between the BET specific surface area determined according to Reference Example 1.1 and the specific micropore surface area S_{mic} determined according to Reference Example 1.2.

### Reference Example 1.4: Determination of Vₜ

The total pore volume (Vₜ) was determined according to DIN 6613 based on the peak value in the physisorption isotherm (volume adsorbed at p/p₀0.994).

### Reference Example 1.5: Determination of V_{mic}

The micropore volume (V_{mic}) was determined according to the method of Reference Example 1.1, calculated by T-Plot method.

### Reference Example 1.6: Determination of V_{BJH}

V_{BJH}, the adsorption cumulative volume of pores between 17.000 and 3.000.000 Angstrom diameter, was calculated according to the Barrett-Joiner-Halenda (BJH) method.

### Reference Example 1.7: Determination of the Loading of the Zeolitic Material on the Support Material

The loading L of the support material with respect to the zeolitic material was calculated according to the equation

L=[S_{BET}(ZM@SiC)]/[S_{BET}(SiC)+S_{BET}(ZM)]

wherein
S_{BET}(ZM©SiC)=specific surface area of the zeolitic material supported on SiC support material
S_{BET}(SiC)=specific surface area of the SiC support material
S_{BET}(ZM)=specific surface area of the zeolitic material
   wherein the respective specific surface is the BET specific surface area determined according to the method as described in Reference Example 1.1 herein.

### Reference Example 1.8: Determination of the Crystallite Size Via SEM

Scanning electron microscope (SEM) was carried out on a FEI Quanta 200 F microscope, acceleration voltage 0.5-30 kV, magnification 120-5000.

### Reference Example 1.9: Determination of the Powder XRD Patterns

Powder X-ray diffraction (XRD) was performed on a Panalytical X'pert Empyrean-100 diffractometer using a Cu Kalpha source (lambda=1.5418 Angstrom) at 40 kV and 40 mA. The patterns were recorded in a range of 2 theta=5 to 50°.

### Reference Example 1.10: Determination of the Cu Loadings

The Cu loadings were measured on a PerkinElmer 7300 DV inductively coupled plasma optical emission spectrometry (ICP-OES).

### Reference Example 2.1: Preparation of a Zeolitic Material Having Framework Type CHA

NaOH was purchased from Sinopharm Chemical Reagent Co., Ltd. N,N,N-trimethyl-1-ammonium adamantane (TMAdaOH) was purchased from Innochem, Al(OH)₃ from Tianjin Kernel Chemical Reagent Co., Ltd. Fine SiO₂ powder was purchased from Shenyang Chemical Industry Co., Ltd. All chemicals were directly used as received without subjected to further purification.

A zeolitic material having framework type CHA was synthesized by hydrothermal synthesis according to the method reported in Shishkin et al. 4 g H₂O were added to 3 g NaOH aqueous solution (1 mol/L), followed by addition of 4 g TMAdaOH (N,N,N-trimethyl-2-adamantylammonium hydroxide). After stirring for 30 min, 0.1 g Al(OH)₃ and 1.2 g SiO₂ were added to the mixture. The resulting suspension was transferred into a Teflon-lined stainless-steel autoclave with a capacity of 50 mL. The autoclave was sealed and kept at 160° C. for 2 d in a rotary oven (0.7 rpm) and subsequently cooled to room temperature. The white powder was washed with ethanol and deionized water three times respectively by suction filtration, followed by drying in air at 100° C. overnight and finally was calcined at 550° C. for 5 h.

### Reference Example 2.2: Preparation of a Zeolitic Material Having Framework Type CHA Comprising Cu

A zeolitic material having framework type CHA comprising Cu was prepared via an ion exchange process. For this purpose, the zeolitic material prepared according to Reference Example 2.1 was put into 0.5 a mol/L Cu(NO₃)₂ aqueous solution with a solid-to-liquid ratio of 0.5 g/30 ml in a Teflon-lined stainless-steel autoclave with a capacity of 50 ml. The autoclave was sealed and kept at 80° C. for 5 hours in a rotary oven (0.7 rpm) and subsequently cooled to room temperature. The solid was then ultrasonically cleaned using deionized water three times, followed by drying in air at 100° C. overnight and finally was calcined at 550° C. for 5 h. The resulting zeolitic material having framework type CHA contained 4.03 weight-% Cu.

### Example 1: Preparation of a Composition Comprising a Zeolitic Material Having Framework Type CHA Supported on Silicon Carbide

A composition zeolitic material having framework type CHA supported on silicon carbide was prepared by growing a zeolitic material via hydrothermal synthesis on a silicon carbide support. First, the synthesis mixture was prepared as described in Reference Example 2.1 above. Then, silicon carbide bricks (67 weight-% alpha-SiC, 18 weight-% Si, 15 weight-% SiO₂) with a dimension of 0.5 cm×0.5 cm×1 cm were put into the synthesis mixture in an autoclave of 50 mL. After crystallization at 160° C. in a rotary oven (0.7 rpm) for a varying period of time (1 to 5 days), the bricks supported with the zeolitic material were collected and ultrasonically washed with deionized water in beaker and dried in air at 100° C. overnight. The final composition comprising a zeolitic material having framework type CHA supported on silicon carbide was obtained after calcination for 5 h at 550° C. The following compositions were obtained (see Table 1 below):

TABLE 1
Compositions prepared according to Example 1

| Compo- | S_{BET}/ | S_{mic}/ | Sₑₓₜ/ | Vₜ/ | V_{mic}/ | V_{BJH}/ | Loading/ |
|---|---|---|---|---|---|---|---|
| sition | m²/g | m²/g | m²/g | cm³/g | cm³/g | cm³/g | % |
| after 1 d | 22.0 | 11.3 | 10.6 | 0.039 | 0.006 | 0.030 | 3.9 |
| after 2 d | 153.9 | 150.4 | 3.5 | 0.090 | 0.081 | 0.007 | 27.1 |
| after 3 d | 201.3 | 193.9 | 7.4 | 0.117 | 0.104 | 0.010 | 35.4 |
| after 4 d | 197.4 | 189.5 | 7.9 | 0.119 | 0.103 | 0.013 | 34.7 |
| after 5 d | 196.8 | 188.6 | 8.2 | 0.118 | 0.101 | 0.014 | 34.6 |
| SiC ¹⁾ | 0.5 | 1.2 | — | 0.001 | 0.001 | 0.001 | — |
| CHA ²⁾ | 567.7 | 560.1 | 7.6 | 0.313 | 0.303 | 0.006 | — |

¹⁾ SiC support material used
²⁾ Zeolitic material powder having framework type CHA prepared according the Reference Example 2.1

FIG. 1 shows XRD patterns of the SiC support material, the pure CHA zeolitic material and a typical CHA zeolitic material supported on the SiC support material. The peak at 21.6° over the SiC support is indexed as the crystal planes of cubic SiO₂ (111) (PDF #27-0605), the 34.1°, 35.6°, 38.1°, 41.4° and 45.3° peaks are characteristic diffraction of hexagonal SiC (101), (006), (103), (104) and (105) (PDF #49-1428), and 28.4° and 47.3° are indexed as the cubic Si (111) and (220) planes (PDF #27-1402), respectively. The XRD pattern of the CHA zeolitic material sample showed well-crystallized CHA structure without impurity. FIG. 1(c) shows that a layer of CHA zeolitic material was grown on the SiC support material. Furthermore, the structure of the SiC support material was not damaged during supporting since all characteristic diffraction peaks were retained. The SiO₂ and Si diffraction peaks initially present in the SiC support disappeared. Without wanting to be bound by any theory, it is noted that this is probably because SiO₂ and Si were consumed as a silicon source when growing the CHA zeolitic material on the surface of the SiC support material.

FIG. 2 shows that the fresh SiC support material was almost black (FIG. 2(a)). Following hydrothermal synthesis for 5 d in the rotating oven (FIG. 2(d)), it turned to pale white, thus showing that surface of the SiC support material was successfully covered with the CHA zeolitic material. When the finally obtained composition comprising the zeolitic material supported on the SiC support material was repeatedly rubbed on a piece of black cloth, no obvious white powder peeled off. This indicated that the CHA zeolitic material was s rather strongly attached to the SiC support material. Without wanting to be bound by any theory, this strong attachment could be due to chemical bonding at the interface which in turn might be due to the fact that the SIC support material contained SiO₂ and Si which act as Si source for the nucleation and crystallization of the CHA zeolitic material during the hydrothermal synthesis. This result was consistent with XRD analysis. Comparison between the images in FIGS. 2(b) and 2(e) shows that the disordered holes of the SiC support material were filled with the CHA zeolitic material and thus the surface was smoother. Closer inspection of FIG. 2(f) and its inset reveals the characteristic cubic morphology of the CHA zeolitic material.

The nitrogen adsorption/desorption curves of the compositions and compounds of Table 1 are shown in FIG. 5(a). Pure CHA zeolitic material prepared according to Reference Example 1.2 shows a type-I isotherm which is characteristic of microporous materials. Its BET surface area was 567.7 m²g⁻¹ and its total pore volume and microporous pore volume are 0.313 and 0.303 cm³g⁻¹, respectively. The SiC support material showed a negligible pore volume and external surface area. After the growth of the CHA zeolitic material on the SiC support material, the surface area increased with the synthesis time from 22.0 to 201.3 m²g⁻¹ corresponding to 1 to 3 days. Beyond 3 days, the specific surface area did not change further (FIG. 5(b)). Since SiC presents an insignificant adsorption of N₂ and specific surface area, the loading of the CHA zeolitic material on the SiC surface increased with the synthesis time. Although the BET specific surface area and the microporous pore volume of the CHA zeolitic material supported on the SIC support material were lower than pure CHA zeolitic material because the SIC itself only contributed the weight but not pores, the composition (after 5 d) showed a relatively high BET specific surface area (196.8 m²g⁻¹), and micropore volume (0.101 cm³g⁻¹).

The synthesis was repeated as described, however with varying amounts of NaOH aqueous solution used. Summarized, the following amounts were used: 2 g, 3 g, 4 g, 5 g, 6 g. It was found that the amount of NaOH had an effect on the growth of the zeolitic material on the SiC support. The results are shown in FIG. 3. FIG. 3(a) shows that the resulting zeolitic material having framework type CHA grown on the SiC support exhibits a relatively low crystallinity when 2 g NaOH aqueous solution was used. With an increasing amount of NaOH, the diffraction peaks of impurity became weaker, and finally disappeared at 5 g NaOH. When the amount of NaOH was further increased to 6 g, only pure CHA phase was observed with a high crystallinity. This was validated by SEM, as shown in FIG. 3(b) to FIG. 3(f). A lot of mussy and elliptical blocks were generated at 2 g NaOH solution, while few small CHA cubes were scattered on the support. With an amount of 4 g NaOH, more and more cubes emerged, while impurities with irregular shapes gradually reduced in number and finally disappeared (FIG. 3(e) and FIG. 3(f)). The size of these cubes of the zeolitic material on the SiC support material varied from 2 to 7 micrometer.

Further, the synthesis was repeated as described, however with varying crystallization times. Summarized, the following times were used: 1 d, 2 d, 3 d, 4 d, 5 d. The amount of NaOH aqueous solution was 5 g. The results are shown in FIG. 4. The XRD patterns in FIG. 4(a) hardly show characteristic diffraction of the zeolitic material if the synthesis is carried out for only one day. FIG. 4(b) shows that some sporadic cubic crystals are present on the surface of the SIC support material, and a portion of the surface of the SiC support material was still exposed after the first day. With extended hydrothermal synthesis time, the crystallinity becomes stronger, reflected by the larger and more angular crystals in the SEM images as shown in FIG. 4. Furthermore, the surface of the SiC support material was fully covered after two days. The samples prepared for 2 to 5 d all show pure phase CHA material with no other impurity phase observed in the XRD patterns. It is shown in FIG. 4(c) that the SiC support material was carpeted with CHA crystals after two days, and the surface of the SiC support material was completely covered.

### Example 2: Preparation of a Zeolitic Material Comprising Cu and Having Framework Type CHA Supported on Silicon Carbide

A zeolitic material comprising Cu and having framework type CHA supported on silicon carbide was prepared via an ion exchange process. For this purpose, the final composition comprising a zeolitic, material having framework type CHA supported on silicon carbide prepared according to Example 1 (amount of NaOH used for hydrothermal synthesis: 5 g; crystallization time: 3 d) was put into 0.5 a mol/L Cu(NO₃)₂ aqueous solution with a solid-to-liquid ratio of 0.8 g/30 ml. The autoclave was sealed and kept at 80° C. for varying periods of time (5 to 20 hours) in a rotary oven (0.7 rpm) and subsequently cooled to room temperature. The composition was then ultrasonically cleaned using deionized water three times, followed by drying in air at 100° C. overnight and finally was calcined at 550° C. for 5 h. The resulting composition contained 0.37 weight-% Cu (having been kept at 80° C. for 5 hours), 1.71 weight-% (having been kept at 80° C. for 10 hours), and 1.02 weight-% (having been kept at 80° C. for 20 hours). The resulting catalyst was named as Cu(x)-SSZ-13@SiC, in which x represents Cu loading (in mass percentage).

### Example 3: Determination of the NH₃-SCR Activity

The catalysts with a size of 40˜60 mesh were loaded into a fixed bed tubular microreactor made of quartz with an inner diameter of 6 mm. The reactions were carried out under conditions: composition of the feed stream: 500 ppm NH₃, 500 ppm NO, 10 volume-% I O₂, 5 volume-% H₂O, balance N₂, 400 ml/min total gas flow and 80000 h⁻¹ gas hourly space velocity (GHSV). The concentration of NO in the effluent stream was analysed using an ECOTCH ML9841AS analyser. NO conversion was calculated according to the following equation:

NO conversion/%=100×[cᵢₙ(NO)−cₒᵤₜ(NO]/cᵢₙ(NO)

wherein
cᵢₙ(NO)=concentration of NO in the feed stream
cₒᵤₜ(NO)=concentration of NO in the effluent stream

FIG. 6 shows the NH₃-SCR performance of the copper containing zeolitic material having framework type CHA, prepared according to Reference Example 1.2, and compositions containing copper prepared according to Example 2 Cu-SSZ-13@SiC catalysts with different Cu loadings. As shown in FIG. 6, NO conversion increased with the Cu loading of the compositions. The catalyst with a loading of 0.37 weight-% (denoted as Cu(0.37)-SSZ-13@SiC) gave the lowest activity. Hardly any conversion of NO to N₂ is observed at low temperatures. The highest NO conversion is only 44 weight-% at 350° C. Cu-SSZ-13@SiC with a Cu loading of 1.02 weight-% (Cu(1.02)-SSZ-13@SiC) performed better and the NO conversion reached 90% at 240° C. and is above 90% up to 380° C. Cu(1.71)-SSZ-13@SiC expands the application temperature since NO conversion above 90% was reached already at a temperature as low as 195° C., and it remained at this level up to 435° C. FIG. 6 shows the NO conversion over Cu(4.04)-SSZ-13 was practically the same as that over Cu(1.71)-SSZ-13@SiC below 250° C. However, it gradually deactivated with the increasing temperature, and the NO conversion dropped to below 90% at 365° C., lower than that of Cu(1.71)-SSZ-13@SiC. This clearly demonstrates the effects of SiC in enhancing the activity and/or stabilizing Cu-SSZ-13 at high temperatures. If activity is expressed as converted NO per gram Cu per minute, the Cu(1.71)-SSZ-13@SiC catalyst gives 35.9 mol NO per gram Cu per minute, which is 7.3 times that Cu(4.04)-SSZ-13 at 550° C.

### SHORT DESCRIPTION OF THE FIGURES

FIG. 1 shows XRD patterns of the SiC support material, the pure CHA zeolitic material and a typical CHA zeolitic material supported on the SiC support material as described in detail in Example 1.

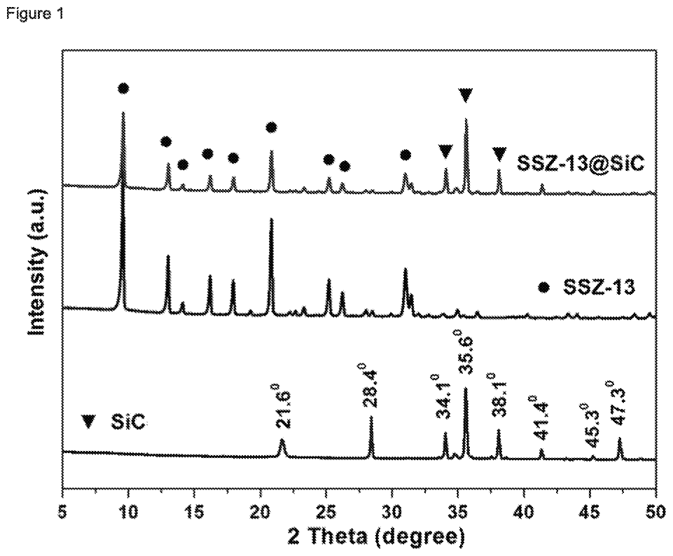

FIG. 2 shows SEM images of the SiC support material in unsupported and supported state, as described in detail in Example 1.

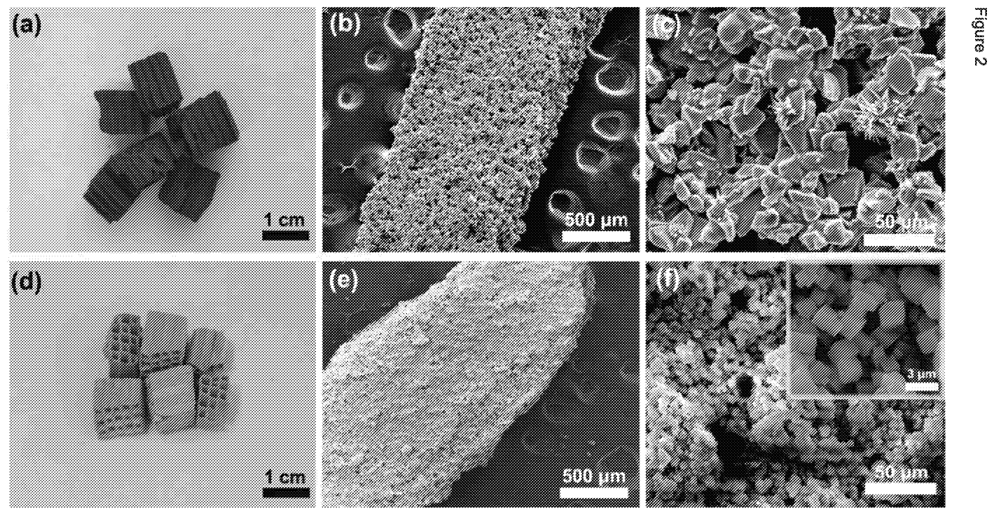

FIG. 3 shows crystal phases and morphologies of compositions comprising a zeolitic material having CHA framework type supported on a SiC support material prepared in the presence of different amounts of NaOH aqueous solution, as described in detail in Example 1.

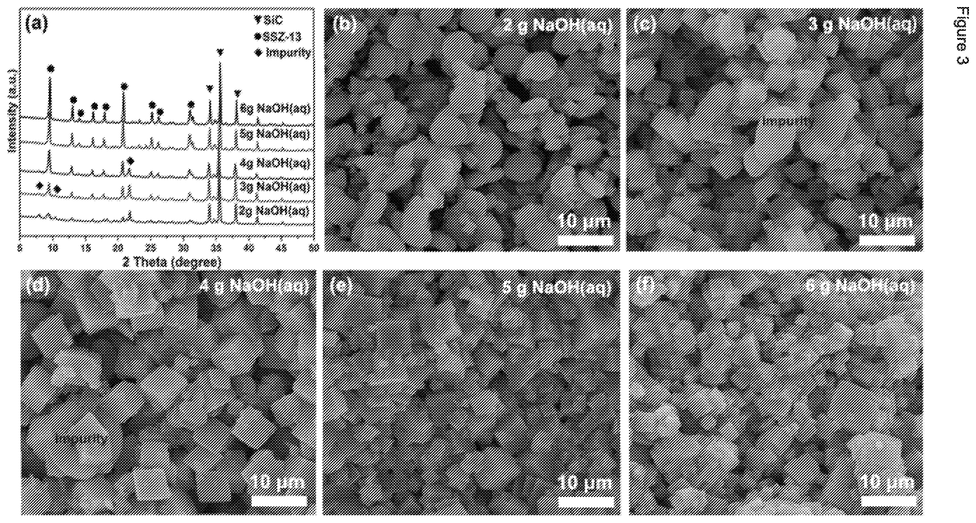

FIG. 4 shows crystal phases and morphologies of compositions comprising a zeolitic material having CHA framework type supported on a SiC support material prepared with different crystallization time, as described in detail in Example 1.

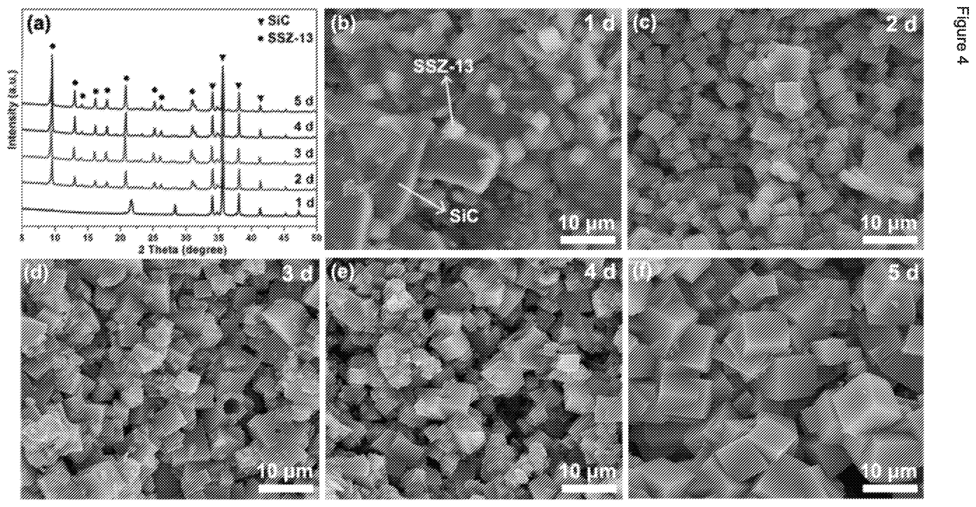

FIG. 5 shows N₂ adsorption/desorption isotherms of a zeolitic, material having framework type CHA, a SiC support material, and a and compositions comprising a zeolitic material having CHA framework type supported on a SiC support material, as well as the BET specific surfacer area of a compositions comprising a zeolitic material having CHA framework type supported on a SiC support material as a function of synthesis time, as described in detail in Example 1

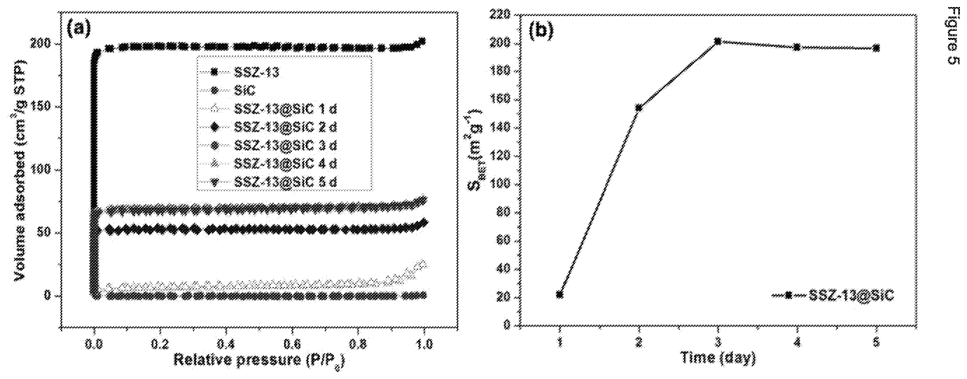

FIG. 6 shows NH₃-SCR performance of a copper containing compositions comprising a zeolitic material having CHA framework type supported on a SiC support material with different copper contents in comparison to an unsupported copper containing zeolitic material having CHA framework.

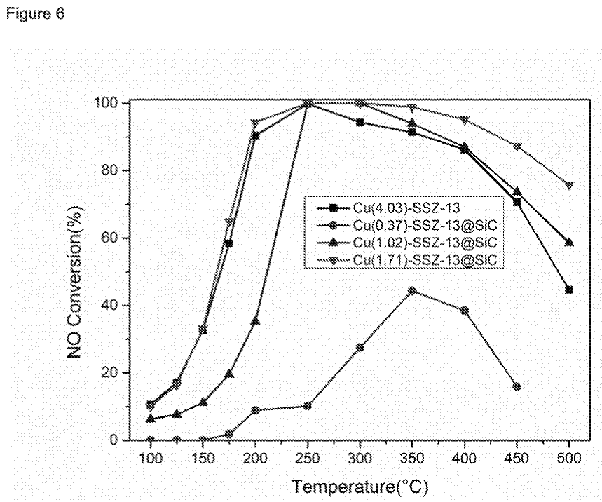

### CITED PRIOR ART

A. Shishkin, H. Kannisto, P. A. Carlsson, H. Harelind, M. Skoglundh; Catal. Sci. Technol. no. 4 (2014); pp. 3917-3926

1. A composition, comprising a support material comprising silicon carbide,
wherein, on a surface of the support material, a zeolitic material of the AEI/CHA family is supported,
wherein at least 99 weight-% of a framework structure of the zeolitic material consists of: a tetravalent element Y which is one or more of Si, Ge, Ti, Sn and V; a trivalent element X which is one or more of Al, Ga, In, and B; O; and H.

2. The composition of claim 1, wherein the silicon carbide comprised in the support material comprises one or more of alpha silicon carbide, beta silicon carbide, and gamma silicon carbide.

3. The composition of claim 1, wherein at least 50 weight % of the support material consists of silicon carbide,
wherein the support material optionally further comprises one or more of elemental silicon and silica.

4. The composition of claim 1, wherein the zeolitic material of the AEI/CHA family is a zeolitic material having framework type AEI or having framework type CHA.

5. The composition of claim 1, wherein the zeolitic material of the AEI/CHA family is a zeolitic material having framework type CHA.

6. The composition of claim 1, having one or more of the following characteristics:
a BET specific surface area in a range of from 100 to 300 m²/g;
a specific micropore surface area in a range of from 100 to 250 m²/g;
an external surface area in a range of from 2 to 10 m²/g;
a total pore volume in a range of from 0.05 to 0.20 cm³/g;
a micropore volume in a range of from 0.04 to 0.15 cm³/g;
an adsorption cumulative pore volume in a range of from 0.002 to 0.02 cm³/g.

7. The composition of claim 1, wherein a loading of the support material with the zeolitic material is in a range of from 5 to 50%.

8. The composition of claim 1, wherein crystallites of the zeolitic material supported on the surface of the support material are in the form of cubes wherein at least 90% of the cubes have an edge length in a range of from 1 to 10 micrometers.

9. The composition of claim 1, further comprising a transition metal.

10. The composition of claim 9, wherein a weight ratio of the transition metal, calculated as element, relative to the zeolitic material is in a range of from 0.1:1 to 5.0:1.

11. A process for preparing the composition of claim 1, the process comprising:
(i) preparing an aqueous synthesis mixture comprising a source of Y, a source of X, a source of a base, and a support material comprising silicon carbide; and
(ii) subjecting the synthesis mixture prepared in (i) to hydrothermal crystallization conditions, comprising heating the synthesis mixture prepared in (i) under autogenous pressure to a crystallization temperature of the zeolitic material of the AEI/CHA family, to obtain a heated synthesis mixture, and keeping the heated synthesis mixture at the crystallization temperature for a crystallization time, to obtain a crystallization mixture comprising the zeolitic material of the AEI/CHA family supported on the surface of the support material and a mother liquor.

12. The process of claim 11,
wherein Y is Si and the source of Y comprises one or more of a silicate, a silica, a silicic acid, a colloidal silica, a fumed silica, a tetraalkoxysilane, a silica hydroxide, a precipitated silica and a clay;
wherein X is Al and the source of X is one or more of a metallic aluminum, an aluminate, an aluminum alcoholate and an aluminum hydroxide; and
wherein the source of the base is a source of one or more of an alkali metal and an alkaline earth metal.

13. The process of claim 11, wherein in the synthesis mixture prepared in (i) and subjected to (ii), a weight ratio of the base relative to the sum of a weight of the source of Y, calculated as YO₂, and a weight of the source of X, calculated as X(OH)₃, is greater than 1.5:1.

14. The process of claim 11,
wherein the zeolitic material has framework type CHA, and
wherein the synthesis mixture prepared in (i) and subjected to (ii) further comprises a CHA framework structure directing agent comprising one or more of a N-alkyl-3-quinuclidinol, a N,N,N-trialkyl-exoaminonorbornane, a N,N,N-trimethyl-1-adamantylammonium compound, a N,N,N-trimethyl-2-adamantylammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzylammonium compound.

15. The process of claim 11, wherein the crystallization temperature according to (ii) is in a range of from 130 to 200° C.

16. The process of claim 11, further comprising subjecting the zeolitic material of the AEI/CHA family supported on the surface of the support material to ion-exchange with a transition metal.

17. A composition, comprising a support material comprising silicon carbide,
wherein, on a surface of the support material, a zeolitic material of the AEI/CHA family is supported,
wherein at least 99 weight-% of a framework structure of the zeolitic material consists of: a tetravalent element Y which is one or more of Si, Ge, Ti, Sn and V; a trivalent element X which is one or more of Al, Ga, In, and B; O; and H, and
wherein the composition is obtainable or obtained by the process of claim 11.

18. An article, wherein the article is a catalyst or a catalyst component comprising the composition of claim 1.

19. A method of treating an exhaust gas stream, the method comprising contacting the exhaust gas stream with the article of claim 18.
